(19) United States
(12) Patent Application Publication
(10) Pub. No.: US 2008/0215285 A1
(43) Pub. Date: Sep. 4, 2008

(54) BOXING TRAINING DEVICE FOR MEASURING AND QUANTIFYING THE RELATIONSHIP BETWEEN THE FORCE AND TIMING OF PUNCHES

(76) Inventor: Mike Bucar, West Palm Beach, FL (US)

Correspondence Address: Edwards Angell Palmer & Dodge LLP, P.O. Box 55874, Boston, MA, 02205, US

(21) Appl. No.: 12/019,879

(22) Filed: Jan. 25, 2008

Related U.S. Application Data
(60) Provisional application No. 60/897,453, filed on Jan. 25, 2007.

(51) Int. Cl. G01L 5/08; G01L 5/00

(52) U.S. Cl. 702/139; 73/862.581

(57) ABSTRACT

A boxing training device comprising a body having an inner layer and an outer layer separated by a gap. A compressible fluid is disposed within the gap. A sensor for sensing the pressure within the gap upon compression of the fluid is disposed within the gap. A circuit, including the sensor determines and displays the force of an impact to the outer layer, which causes compression.

### CROSS-REFERENCE TO RELATED APPLICATIONS

This Application is a Non-Provisional of Provisional Application No. 60/897,453, entitled BOXING TRAINING DEVICE FOR MEASURING AND QUANTIFYING THE RELATIONSHIP BETWEEN THE FORCE AND TIMING OF PUNCHES, filed on Jan. 25, 2007 under 35 USC 119(e).

### BACKGROUND OF THE INVENTION

This application is directed to a boxing training device, and more particularly, a device that provides feedback to a boxer utilizing a heavy bag with respect to the speed and power of punches that are applied in combination.

The art of boxing goes back many centuries. However, the training devices for perfecting punch technique, power and speed have remained unchanged for decades. The two primary tools for a boxer to perfect their boxing technique without requiring another boxer are the speed bag and the heavy bag. The ability to move the heavy bag by punching the heavy bag without feeling excessive reverberation back into the arm and fist of the boxer was empirical evidence that sufficient force was being applied by punches over time.

Similarly, the ability to maintain the speed bag bouncing against its support platform was empirical evidence of the speed at which a combination of punches is thrown. Maintaining the bag in a desired position was empirical evidence of precision and the proper technique. Without the proper technique, the speed bag would not be maintained substantially pinned against its platform and the heavy bag would not move sufficiently.

However, there is no way to measure the actual force of the punches thrown, the timing of individual punches thrown or the overall force applied to the bags; particularly with respect to the combination punches. Furthermore, over time, punching bags deteriorate and become less and less uniform across bags at a gym as a result of use. Therefore, there is no consistency in the empirical feedback across a number of speed bags or heavy bags.

Accordingly, it is desirable to develop a product that overcomes the deficiencies of the prior art.

### BRIEF SUMMARY OF THE INVENTION

A bladder is adapted to be disposed about the exterior of a heavy bag. The bladder is filled with a fluid (either a gas or a liquid). A sensor is disposed within the bladder to detect changes in pressure within the bladder, which are the result of impacts received at the bag. A processor receives the input from the sensor and determines the force applied to the sensor and the time at which the impact occurred. The processor may also include a clock for determining a time interval during which the sensor will detect all impacts to the bag or the elapsed time between successive impacts. A display is provided for displaying at least the force of at least one impact.

In the preferred embodiment, each impact, as sensed by the sensor, is time-stamped by the processor during the interval. The processor calculates the force of each individual impact, the number of impacts sensed during the time interval, the spacing between each respective impact during the interval, and an overall force amount equal to the sum of the force of each impact during the interval.

### BRIEF DESCRIPTION OF THE DRAWINGS

For a fuller understanding of the invention, reference is had to the following description taken in connection with the accompanying drawings in which:

FIG. 1 is a front elevational view of a boxing training device constructed in accordance with the invention;

FIG. 2 is sectional view taken along line 2-2 of FIG. 1;

FIG. 3 is a block diagram of the circuitry provided within the boxing training device in accordance with the invention; and

FIG. 4 is a plan view of one embodiment of a display in accordance with the invention.

### DETAILED DESCRIPTION OF THE INVENTION

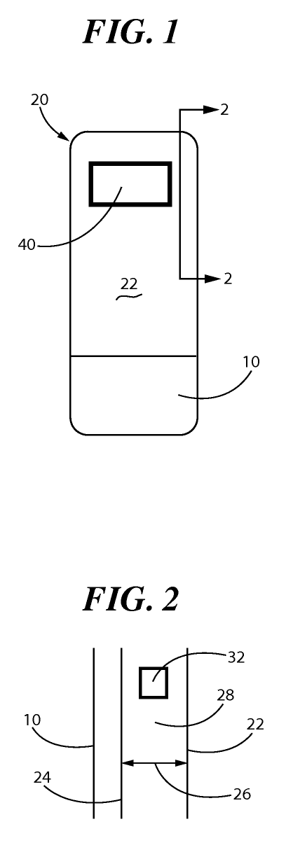

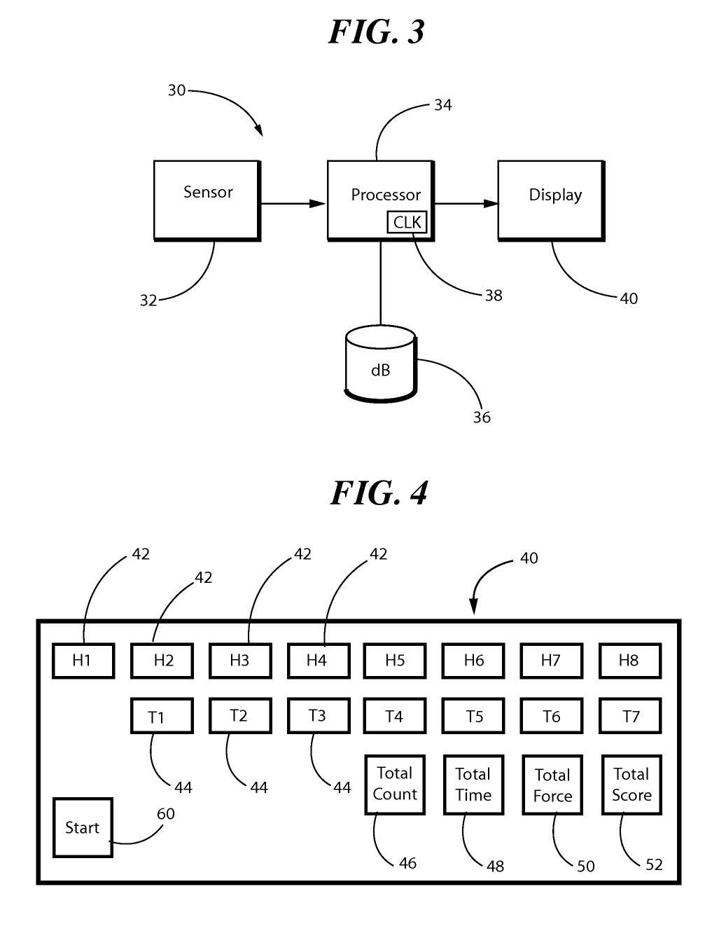

The present invention is adapted for use in measuring punch force and timing when utilizing a heavy bag. Reference is made to FIG. 1 in which the invention, generally indicated as 20 is provided on a heavy bag 10. Boxing training device 20 is a bladder construction having an outer wall 22 and an inner wall 24. A gap 26 is formed there between capable of accommodating a fluid such as air, other gases, or liquids. Outer wall 22 is flexible so that when hit, the outer wall is deflected into gap 26 applying a force and compressing the fluid 28 in direct relation to the force of the impact.

Training device 20 includes a circuit 30. Circuit 30 includes a sensor 32 disposed within gap 26. Sensor 32 detects the change in pressure within gap 26, i.e., the amount of force applied to fluid 28. Sensor 32 outputs a force signal to processor 34 in response to sensing a change in pressure from compression of fluid 28 resulting from an impact such as a punch or kick. In a preferred embodiment sensor 32 is a pressure sensor for detecting a change in pressure in fluid 28 such as a piezoelectric device by way of non-limiting example. Because wall 22 is resilient, it returns to its initial position after impact. Wall 22 may be made out of a rubber, plastic or even a cloth so long as it is sufficiently malleable that the decompression of fluid 22 restores wall 22 to its original position.

Circuit 30 is for monitoring, storing and processing the timing, speed and force of individual punches and punches grouped in combinations. By providing a pressure sensor 32 for sensing compression of the fluid, sensor 32 senses force which is determinable at predetermined distances from the point of impact. Processor 34 converts the sensed pressure to a recognizable applied force value such as pounds. Processor 34 converts the pressure change into an applied force utilizing either an algorithm or look up table stored in a database 36. The determined force is stored by processor 34 in database 36. Processor 34 includes a clock 38. Clock 38 is a running clock and processor 34 utilizes clock 38 to determine a start and stop interval for an overall time as well as for the timing between each punch sensed by sensor 32. Processor 34 stores the overall interval information as well as the time between punch information in database 36. Processor 34 processes the data stored in database 36, such as the overall force sensed during the entire interval, counts the number of punches during an interval, associates an elapsed time from a previous punch with the force of the current punch, which determines a total number of punch count.

Processor 34 outputs a display signal to a display 40 for displaying the information determined by processor 34. Display 40 may be any display, mechanical, electrical, visual or audio capable of communicating the information output by processor 34 to the user.

In a preferred embodiment, circuit 30 is disposed within gap 26 with at least a portion of display 40 communicating outside of layer 22. However, it should also be noted that it is well within the scope of the invention to provide sensor 32 with a transmitter so that the display need not be incorporated into device 20 or bag 10, so that the pressure signal could be transmitted wirelessly or by infrared to processor 34 at a remote location to be monitored at a display by others.

Reference is now made to FIG. 4 in which a preferred, non-limiting exemplary embodiment of display 40 is provided. In this embodiment display 40 is a visual display having hit display region 42 indicating the force of each of a successive number of hits; up to eights hits in this example, time displays 44 displaying an elapsed time between successive hits so that there are displays 44 of time intervals T1-T7.

Furthermore, as discussed above, processor 34 may determine a total number of hits for a total count, which is displayed at a total count display 46. Similarly, a total time interval as measured by processor 34 is displayed a total time display 48. Processor 34, utilizing the raw data hits H1-H8, calculates a total force and outputs that amount as a total force display 50. Lastly, processor 34 utilizes an algorithm for processing the data to determine a score which may be a function of interval times T1-T7 and total force, total time and total force, or individual times and force for the respective number of hits H1-H8. For example, consistent force among punches or increased force and shortened timing between intervals may be the goal and processor 34 determines a score for the completed time interval as a function of the scoring algorithm which is then displayed at a total score display 40 within display 40.

It should be noted that device 20 is shown as adapted to be fit to a bag as an overlay component. However, it is well within the scope of the invention to incorporate the structure of training device 20 within the structure of the bag, i.e., to make them one integral piece.

Furthermore, display 40 may be an LCD panel, a touch screen, a loud speaker, a mechanical display with a rotating wheel and cog configuration, or any type of display capable of displaying individual hits, counts and/or the recorded times.

Furthermore, in a preferred embodiment, display 40 is an input/output device such as a touch screen capable of allowing the programming of processor 34 to instruct processor 34 regarding the mode in which it is to operate as well as to set the parameters for the number of hits to be recorded and/or the time interval.

It should also be noted that displays 42 and 44 need not be fixed but in fact may correspond to the scores of any number of recorded hits and time intervals so that if a time interval is being measured as the time needed to deliver 15 hits, the display, if operating in this reporting mode, would show 15 hit values and 14 time interval values.

During operation, a user would input a start command by hitting a start button 60 somewhere on the apparatus, preferably display 40. Display 40 may then prompt the user for an overall time interval or overall punch count interval to be monitored. An input may be selected for a mode to select the proper algorithm for the total score output as a function of the desired result whether it is speed, consistency or power, or a combination of at least two of the three.

In a preferred embodiment, the clock would actually begin with the first sensed impact after start input 60 had been activated. A boxer punches the training device 20 compressing the fluid 28 within gap 26. Sensor 32 measures the change in pressure and outputs a pressure change signal to processor 34. Processor 34 notes the clock and the force and stores both in database 36.

Processor 34 may send a real time force signal to display 40 or a delayed time and force signal to display 40 so that the user may have real time feedback regarding each of the punches. As a second punch is sensed, the process is repeated.

Processor 34 samples clock 38 to determine an elapsed time interval and stores either the elapsed time interval or the raw clock reading along with the force of the second punch in database 36 for later calculations. This process is repeated until either the desired number of punches or the desired elapsed time has occurred. The sensor is then disabled, i.e., processor 34 no longer operates on its inputs and the displays as discussed above such as total count, total time, total force and/or total score along with the individual values of each punch are provided.

It should be noted that punching was used as the most common example. However, all that is really being measured is compression within gap 26 so that any impact such as from a foot, or any other body part such as in a martial art's use can also be processed.

Thus, by providing compressible structure and a sensor within the structure for determining the extent of the compression and the force required to make such compression and display that force, a training device for boxing or other contact sports in which hitting is required is provided. By utilizing a processor, which stores each individual impact and a corresponding time, processor 34 is able to determine and display desired information about the overall punching and combination of punches. The device provides a method of quantifying the relationship between the raw data to determine a score representative of a fighter's efficiency of applying speed and power to a target.

Thus, while there have been shown, described and pointed out novel features of the present invention as applied to the preferred embodiments thereof, it will be understood that various omissions and substitutions and changes in form and detail are contemplated so that the disclosed invention may be made by those skilled in the art without departing from the spirit of the invention. It is the intention therefore to be limited only as indicated by the scope of the claims appended hereto. It is also to be understood that the following claims are intended to cover all of the generic and specific features of the invention herein described and all statements of the scope of the invention, which is a matter of language, might be said to fall therebetween.

What is claimed as new and desired to be protected by Letters Patent of the United States is:

1. A boxing training device comprising:
a body;
the body having an inner layer and an outer layer separated by a gap;
a compressible fluid disposed within the gap;
a sensor for sensing a pressure change within the gap upon a compression of the fluid; and
a circuit, including the sensor, configured for determining and displaying at least the force of an impact to the outer layer causing the compression.

2. The boxing training device of claim 1, wherein said body is adapted to receive a heavy bag therein.

3. The boxing training device of claim 1, wherein the circuit includes a processor receiving a pressure change input from the sensor;
the processor converting a value of the pressure change signal to a force value; and
a database associated with the processor;
a display; and
the processor performing at least one of displaying the force value at the display and storing the force value in the database.

4. The boxing training device of claim 1, wherein the circuit includes a processor and a database;
the processor receiving a pressure change signal from the sensor and determining a force value of impact corresponding to the compression and storing said force value in said database.

5. The boxing training device of claim 1, wherein the circuit includes a processor, the processor including a clock, the clock producing a clock signal, and the processor processing the clock signal to determine an elapsed time between a first compression sensed by the sensor and a second compression sensed by the sensor.

6. The boxing training device of claim 5, wherein said processor receives a first pressure change signal from the sensor as a function of the first compression and determines a first force value of impact corresponding to the compression and stores the first force value in said database, receives a pressure change signal from the sensor and determines a second force value of impact corresponding to the second compression and stores said second force value in said database and determines an overall force value for said elapsed time corresponding to a sum of the first force value and second force value.

7. The boxing training device of claim 5, wherein said processor receives a first pressure change signal from the sensor as a function of the first compression and determines a first force value of impact corresponding to the compression and stores the first force value in said database, receives a pressure change signal from the sensor and determines a second force value of impact corresponding to the second compression and stores said second force value in said database, the processor outputting a display signal to said display, causing said display to display the first compression value, second compression value, and the elapsed time between said first compression and second compression.

8. The boxing training device of claim 5, wherein said processor counts the first compression and second compression as it determines the total number of compressions sensed during an overall time period.
